(19) United States
(12) Patent Application Publication
(10) Pub. No.: US 2014/0339092 A1
(43) Pub. Date: Nov. 20, 2014

(54) METHOD FOR PRODUCING ELECTRICALLY CONDUCTIVE STRUCTURES ON NON-CONDUCTIVE SUBSTRATES AND STRUCTURES MADE IN THIS MATTER

(71) Applicant: BYK-Chemie GmbH, Wesel (DE)

(72) Inventors: Michael Berkei, Haltern am See (DE); Tobias Tinthoff, Rees-Haldern (DE)

(21) Appl. No.: 14/362,274

(22) PCT Filed: Nov. 30, 2012
(86) PCT No.: PCT/EP2012/004965

§ 371 Date: Jun. 2, 2014

(30) Foreign Application Priority Data
Dec. 2, 2011 (EP) 11009542.9

(51) Int. Cl. C25D 5/54; H01B 1/02; H01B 1/04; H01B 13/00; H01B 5/14

(52) U.S. Cl. CPC C25D 5/54; H01B 13/0026; H01B 5/14; H01B 1/04; H01B 1/02
USPC 205/50; 205/183

(57) ABSTRACT

The method relates to a method for producing electrically conductive structures on electrically non-conductive substrates and to a method for the electrochemical deposition of metals on substrates, which is suitable in particular for producing metallic structures and/or electroplated plastics. The invention further relates to products obtainable in this way and to the use thereof.

### CROSS-REFERENCES TO RELATED APPLICATIONS

This application is a National Stage filing of International Application PCT/EP 2012/004965, filed Nov. 30, 2012, claiming priority to EP 11 009 542.9 filed Dec. 2, 2011, entitled “METHOD FOR PRODUCING ELECTRICALLY CONDUCTIVE STRUCTURES ON NON-CONDUCTIVE SUBSTRATES AND STRUCTURES MADE IN THIS MATTER.” The subject application claims priority to PCT/EP 2012/004965, and to EP 11 009 542.9 and incorporates all by reference herein, in their entirety.

### BACKGROUND OF THE INVENTION

The present invention relates to the technical field of the production of electrically conductive structures.

The invention relates more particularly to a method for producing electrically conductive structures on electrically nonconducting substrates, more particularly to a method for electrochemical deposition of metals on substrates. The method of the invention is suitable for producing conductive structures, more particularly conductive metallic structures and/or electroformed products.

The present invention further relates to the conductive structures, more particularly conductive metallic structures, that are obtainable by the method of the invention, and also to their use.

In the production of conductive structures, such as, for example, conductive coatings, and of miniaturized objects and workpieces, more particularly electrical and precision-mechanical components, the methods available to the skilled person include primarily those which remove material and those which apply material. The material-removing techniques include, for example, etching, milling, grinding, etc., while examples of material-applying methods include printing, casting, sputtering, etc.

In the case of the material-removing methods, the amounts of material introduced initially are greater than are needed for production of the products. Removal of the excess material then affords the desired shape or desired product. The portion of the material that is removed must subsequently be used again for shaping, or recovered, in costly and inconvenient operations. These operations give rise to unnecessary process costs and materials costs, this being a disadvantage in particular on account of continually increasing prices for raw materials and energy, and also from the standpoint of protecting the environment. Furthermore, in the case of complex geometries, the process costs are increased to a point where industrial production cannot be carried out in an economically rational way.

In the case of the material-applying methods, in contrast, material is applied to a substrate or introduced into a mold, with the amount of material used being, as far as possible, only that which is also necessary for the production of the desired article or desired structure. Material-applying methods therefore permit coatings and microstructures to be produced in a way which is efficient in terms of the use of resources and starting materials. In this way, for example, fine conductor tracks can be produced by print application of silver pastes; owing to the size of the silver particles and the high viscosity of the pastes, however, it is not possible to carry out the majority of printing methods, especially the technically refined and inexpensive inkjet printing method. If, on the other hand, inks containing silver nanoparticles are used, the printed conductor track must first be sintered before sufficient conductivity is obtained. But the sintering operation greatly restricts the options in selection of the substrate material onto which the conductor track is printed, since the plastics-based substrates that are employed with preference in electrical engineering are destroyed by exposure to relatively high temperatures. The production of conductor tracks by chemical deposition via the gas phase that is also practiced, more particularly by means of CVD (Chemical Vapor Deposition) methods, is in general very inconvenient and costly.

The production of microstructured articles and components by customary material-applying methods, such as casting technologies, for example, is also difficult. Casting methods in particular have only extremely limited suitability for the production of uniform coatings and microstructured articles, since the surface tension of the casting composition is rarely conducive to uniform wetting of the casting mold, particularly in the case of very fine structures.

Another material-applying method that is utilized in particular is the electrolytic or electroplating deposition of metals on substrates for the production of electrically conductive coatings. Galvanizing is employed in particular as a method of reproduction or for producing electroformed products. In the case of the production of electroformed products, a nonconducting mold of the article to be modeled, which in general will be subsequently destroyed, is produced first of all, and then coated with an electrically conductive layer. The electrically conductive layer is produced using techniques, for example, such as graphitizing, where ultrafine graphite dust is scattered onto the mold and then spread using fine or coarse brushes, to produce a coherent conductive layer. The application of metal powders is employed, furthermore, in the same way as with graphitizing.

Other methods of generating electrically conductive coatings for galvanizing are, for example, the application of silver solutions, with subsequent reduction of the dissolved silver to elemental silver, and also coating with elemental metals. The aforementioned techniques all have the disadvantage, though, that the adhesion of the conductive medium on the nonconducting mold is often inadequate; relatively high film thicknesses are necessary in order to obtain sufficient conductivities; or the methods can be carried out only with considerably costly and complex apparatus and at high cost.

In the prior art, consequently, there has been no lack of attempts to improve the efficiency of galvanizing methods:

Disclosed by EP 0 698 132 B1/U.S. Pat. No. 5,389,270 A is a method/composition for electrochemical coating of a circuit board substrate with a conducting metal layer, in which a dispersion of electrically conducting graphite is applied to the conducting and nonconducting surface regions of the circuit board, the circuit board is etched, and then the substrate is coated electrochemically.

Furthermore, EP 0 200 398 B1 relates to a method for electroplating a conducting metal layer onto the surface of a nonconducting material, in which a carbon black dispersion is applied to the nonconducting material and then the surface of the substrate is electrochemically coated or electroplated.

DE 198 06 360 A1 relates to a method for electrolytic deposition of a metal layer with a smooth surface on a substrate, using a graphite dispersion, in which a substrate is contacted with a dispersion comprising graphite particles, after which a metal layer is deposited electrolytically on the graphite layer.

Lastly, EP 0 616 558 B1 relates to a method for coating of surfaces with fine particulate solids, in which the substrate to be coated is pretreated with polyelectrolytes in a bath, after which the substrate thus treated is immersed into a second bath containing a dispersion of solids. The particulate solids remain adhering to the substrate surface by coagulation, and by this means it is said to be possible to obtain, in particular, conductive layers, among others.

Common to all of these methods, however, is that they do not significantly improve the adhesion of the electrically conductive layer on the substrate, or its abrasion resistance, and in general permit only full-area wetting of the substrate. Regioselective or locally limited coating of nonconducting substrates is therefore difficult or impossible to obtain with these methods.

In particular, the aforementioned starting materials and methods can generally not be combined with inexpensive printing methods, and in terms of their applicability are restricted to specific method parameters and materials, and, consequently, cannot be deployed flexibly.

### BRIEF SUMMARY OF THE INVENTION

It is an object of the present invention, therefore, to provide a method for producing conductive structures on nonconducting substrates, in which the problems and disadvantages outlined above that occur in connection with the prior art are at least largely avoided or else at least diminished.

One object of the present invention is seen, in particular, as being that of applying solubilisates or dispersions of nonmetallic, conductive materials to nonconducting substrates in such a way as to obtain highly conductive layers with a very low thickness. At the same time, in particular, the application ought to be regioselective or locationally specific and locally limited, by means of simple methods.

An object of the present invention, moreover, is that of providing two- and three-dimensional structures and objects, particularly microstructured or miniaturized components and workpieces, in a simple and efficient way, through electrochemical deposition of metals onto nonmetallic substrates.

The objectives outlined above are achieved in accordance with the invention by a method described herein; further, advantageous developments and embodiments of the method of the invention are similarly described.

Further provided by the present invention are electrically conductive metallic structures also described.

Yet further provided by the present invention is the use of the electrically conductive structures disclosed.

Additionally provided by the present invention, lastly, are products or articles which comprise the electrically conductive structures according to the invention.

It will be readily appreciated that embodiments, refinements, advantages, or the like, which are set out below in relation only to one aspect of the invention, in order to avoid unnecessary repetition, of course also apply correspondingly in relation to the other aspects of the invention.

It will also be readily appreciated that where values, numbers, and ranges are specified below, the relevant specifications of value, number, and range are not to be construed as limiting; to a skilled person it will be readily apparent that, in individual cases or in particular applications, deviations may be made from the specified ranges or specifications, without departing the scope of the present invention.

It is the case, moreover, that all value specifications or parameter specifications identified below, or similar, can in principle be ascertained or determined by standardized or normalized, or explicitly specified, methods of determination, or else by methods of determination that are familiar per se to a person skilled in this field.

Furthermore, in the context of the percentage statement of quantities of ingredients employed, the quantitative proportions should be combined in such a way as to result in total in 100% or 100 wt %.
Subject to these provisos, the present invention is described in more detail hereinafter.

### DETAILED DESCRIPTION OF THE INVENTION

The present invention accordingly provides—in accordance with a first aspect of the present invention—a method for electrochemical deposition of metals on substrates, more particularly for producing metallic structures and/or electroformed products,
(a) where, in a first step of the method, at least one solubilisate and/or dispersion based on electrically conductive materials selected from the group consisting of electrically conductive carbon allotropes, electrically conductive polymers, and electrically conductive inorganic oxides, is applied to an electrically nonconducting substrate, in particular where the application of the solubilisate and/or dispersion is carried out with local limitation and/or locational specificity, more particularly by means of printing methods,
(b) where, optionally, a subsequent method step of drying and/or curing the solubilisate and/or dispersion is carried out, and
(c) where, in a subsequent method step, at least one metal is deposited electrochemically on the optionally dried and/or cured solubilisate and/or on the optionally dried and/or cured dispersion.

As described above, in a method step (a), at least one solubilisate or dispersion based on electrically conductive materials selected from the group consisting of electrically conductive carbon allotropes, electrically conductive polymers, and electrically conductive inorganic oxides is applied to an electrically nonconducting substrate.

In this context it has proven advantageous if the application of the solubilisate and/or dispersion is carried out with local limitation or locational specificity or regioselectivity, in particular by means of printing methods (i.e., by means of printing).

Optionally, following method step (a), a subsequent method step (b) of drying and/or curing of the solubilisate or dispersion applied in this way is carried out.

Electrical conductivity in the context of the present invention means in particular the capacity to conduct electrical current. The electrical conductivity of the conductive structures obtainable by the method of the invention is generally within the values for typical conductors and semiconductors, i.e., in general, in the range from 10⁻⁷ to 10⁷ S/m.

The term “solubilisate” refers in the context of the present invention, in the widest sense, to solutions of substances or compounds, more particularly of macromolecules, which in general are not soluble in the relevant solvent without the addition of auxiliaries or additives. Advantageous in particular for the dissolution or solubilization of these substances is the use of a solubilizer, which influences the dissolution properties of the solvent and/or increases, for example, the solubility of the chemical substance or compound in question—as by surfactants in the case of micelle formation.

A dispersion in the context of the present invention means a mixture of at least two phases clearly delimited from one another with no mutual dissolution in one another, or at least substantially none. In dispersions, in particular, at least one phase, namely the dispersed or discontinuous phase, is very finely divided within another phase, i.e., the continuous phase or the dispersion medium. Dispersions may take the form of mixtures of solid phases (solid/solid), solid and liquid phases (solid/liquid and liquid/solid), and also mixtures of gaseous phases with solid or liquid phases (liquid/gaseous, gaseous/liquid, or solid/gaseous). In the context of the present invention solid/liquid systems are generally used, where a solid phase is in dispersion in a liquid dispersion medium; also possible, however, is the use of solid/solid dispersions, such as powder coating materials, for example.

A particular feature of the method of the invention is that the application of the solubilisate or dispersion to the electrically nonconducting substrate can take place with local limitation and/or locational specificity or regioselectivity. A locally limited and/or locationally specific or regioselective application means in particular that the solubilisate or dispersion is applied to the substrate only at very particular, preferably desired or defined locations, resulting in only sectional or incomplete or partial coating of the substrate or carrier.

In this way it is possible to apply conductor tracks made from nonmetallic conductive materials, for example, directly to nonconducting substrates, in particular by means of printing methods, as set out comprehensively below. The conductive structures obtainable by the method of the invention are notable relative to the prior art for a combination of low film thickness with high electrical conductivity and outstanding mechanical robustness and abrasion resistance.

With the method of the invention it is possible, equally, to provide nonconducting substrates with conductive nonmetallic structures in such a way that in a subsequent method step, metals can be deposited on the substrate electrolytically, in particular by means of galvanizing, more particularly in accordance with a specified or defined pattern. With the method of the invention, therefore, it is possible in a simple and efficient way for metallic conductor tracks as well to be generated on electrically nonconducting substrates, without technically complicated steps, such as etching or sintering operations, for example.

It is equally possible, furthermore, with the method of the invention to obtain three-dimensional articles, such as precision-mechanical components or electrical components, for example, by galvanoforming or in the form of electroformed products. Galvanoforming or electroforming is a shaping technique which can be used primarily in order to produce metallic coatings or self-supporting metallic objects or workpieces.

On account of the low layer thickness and the high conductivity of the conductive structures of the invention, it is possible to obtain, within the bounds of the method of the invention, microstructured or miniaturized three-dimensional objects and workpieces with a level of detail and/or resolution that have been hitherto unknown in the prior art.

The basis for the electrically conductive structures obtainable in accordance with the method of the invention are solubilisates or dispersions based on electrically conductive materials, more particularly nonmetallic electrically conductive materials. In the context of the present invention, the expression “solubilisate and/or dispersion based on electrically conductive materials” should be understood to mean that the solubilisate or dispersion comprises at least one electrically conductive material.

In the context of the present invention—as described above—in a subsequent method step (c), more particularly following the method step (a) or the optional method step (b), at least one metal is deposited electrochemically on the electrically conductive structure, more particularly on the optionally dried and/or cured solubilisate and/or on the optionally dried and/or cured dispersion.

As a result of the deposition, more particularly electrolytic deposition, of metals, or galvanizing, as part of method step (c), it is possible in the context of the present invention to obtain metallically conductive structures and also miniaturized or microstructured three-dimensional objects and workpieces of metal by means of galvanoforming, or as an electroformed product.

In the electrolytic deposition of the metals, or galvanizing, the electrically conductive structures applied to the electrically nonconducting substrate are used as cathode, at which the reduction of metal ions and hence deposition of the elemental metals is accomplished.

In the context of the present invention, furthermore, provision may be made for the structure or the three-dimensional metallic object or workpiece obtained by electrochemical deposition of metals to be detached again from the substrate. The method of the invention is therefore also suitable for the efficient and time-saving production, for example, of prototypes, and can therefore also be used as part of rapid prototyping processes.

The method of the invention can therefore be used for producing conductive structures, with metallically conductive structures resulting when the method of the invention is carried out with method steps (a), (b), and (c) or with method steps (a) and (c).

As described above, in the context of the method of the invention, solubilisates or dispersions are used as starting materials that are based on electrically conductive materials, the electrically conductive materials being selectable from the group consisting of electrically conductive carbon allotropes, electrically conductive polymers, and electrically conductive inorganic oxides.

Where electrically conductive carbon allotropes are used as electrically conductive materials for the purposes of the method of the invention, then electrically conductive carbon allotropes used are in general, in the context of the present invention, graphite, graphenes, fullerenes and/or carbon nanotubes (CNTs), especially carbon nanotubes (CNTs).

Through the use of electrically conductive carbon allotropes in the solubilisates or dispersions used in accordance with the invention, it is possible, as compared with the prior art, to obtain thinner film thicknesses of consistent conductivity, and to obtain enhanced abrasion resistance on the part of the optionally dried or cured solubilisates and dispersion.

Particularly good results are obtained for the use of carbon nanotubes (CNTs), and in this context it is possible to use not only single-wall but also multi-wall carbon nanotubes (Single-Wall Carbon Nanotubes (SWCNTs) or Multi-Wall Carbon Nanotubes (MWCNTs)). In comparison to the other carbon allotropes, carbon nanotubes exhibit a further significantly increased electrical conductivity and mechanical robustness, and hence, through the use of carbon nanotubes, particularly thin-layer structures are obtained that at the same time are conductive, abrasion resistant, and mechanically robust.

Dispersions of carbon nanotubes which are used with preference in the context of the present invention may be obtained, for example, by the method described in DE 10 2006 055 106 A1, WO 2008/058589 A2, US 2010/0059720 A1 and CA 2,668,489 A1, the respective disclosure content of which is incorporated in full by reference. The aforesaid documents relate to a method for dispersing carbon nanotubes (CNTs) in a continuous phase, more particularly in at least one dispersion medium, where the carbon nanotubes (CNTs), more particularly without prior pretreatment, are dispersed in a continuous phase, more particularly in at least one dispersion medium, in the presence of at least one dispersant, with introduction of an energy input sufficient for dispersing. The amount of energy introduced during the dispersing operation, calculated as energy input per unit amount of carbon nanotubes (CNTs) to be dispersed, may be in particular 15 000 to 100 000 kJ/kg; dispersants used may in particular be polymeric dispersants, preferably based on functionalized polymers, more particularly having number-average molecular masses of at least 500 g/mol. With these dispersing methods it is possible to obtain stable dispersions of carbon nanotubes (CNTs) having a weight fraction of up to 30 wt % of carbon nanotubes (CNTs).

Provision may also be made for the possible use, as electrically conductive materials, of electrically conductive polymers, more particularly polyacetylenes, polyanilines, polyparaphenylenes, polypyrroles and/or polythiophenes. The electrically conductive polymers may be used alternatively or in combination with the electrically conductive carbon allotropes and/or with the electrically conductive inorganic oxides described below.

In the context of the present invention, equally good results are obtained if electrically conductive materials used are electrically conductive inorganic oxides, more particularly indium tin oxide (ITO), indium zinc oxide (IZO), aluminum zinc oxide (AZO), antimony tin oxide (ATO) and/or fluorine tin oxide (FTO).

The above-described electrically conductive carbon allotropes, electrically conductive polymers, and electrically conductive inorganic oxides may in each case be used individually or else in combination with one another in the solubilisates or dispersions employed in accordance with the invention. The respective use of the materials, particularly in the case of combinations, may be selected by the skilled person on the basis of the external conditions, such as deposition conditions of the metal, substrate materials, end use of the product, etc., for example, with preference being given to the use of carbon nanotubes, particularly as sole electrically conductive material.

In general, in the context of the present invention, the solubilisate and/or dispersion is water-based and/or solvent-based in form. Provision may be made here for the solvent of the solubilisate and/or for the continuous phase of the dispersion to be an aqueous-based, organic-based or organic-aqueous-based solvent and/or dispersion medium.

In the context of the present invention, therefore, solubilisates or dispersions of solid substances in liquid dispersion media are used preferably. Dispersion media or solvents that are used in this context are, in particular, commercial organic solvents, optionally in mixtures, and/or water. Equally, however, it is also possible for polymers that are liquid under application conditions to be used as the dispersion medium.

After application has taken place, the solvent or dispersion medium can be removed (e.g., by drying according to method step (b)), thus leaving the conductive materials, and also any additives that may be present in the solubilisate or dispersion, on the substrate. If the solubilisate or dispersion has sufficiently high viscosities or is at least partly curable in form, the removal of the solvent or dispersion medium may optionally be omitted; in this case, the solvent or dispersion medium influences the mechanical and electrical properties of the conductive structures.

Alternatively, however, it is also possible for the dispersion used in the context of the present invention to be a mixture of solids which is not liquid in particular under the method conditions of application to the substrate. Such conditions are present, for example, if the dispersion of the invention is used in the form of a powder coating material.

According to one preferred embodiment of the present invention, the solubilisate and/or the dispersion is curable, more particularly radiation curable and/or thermally curable, preferably radiation curable, in form. As a result of the curability of the solubilisate or dispersion used in accordance with the invention, the dispersion or solubilisate is cured immediately after application, under controlled and determinable or defined conditions, and the electrically conductive structure can therefore be fixed spatially on the substrate and secured against “running”. The term “radiation-curable” refers in the context of the present invention to the fact in particular that the solubilisate or dispersion is cured by exposure to actinic radiation, more particularly UV radiation, i.e., undergoes transition from the liquid to the solid aggregate state, with a uniform, continuous layer being obtained in particular. An exception is formed here by solid dispersions, such as powder coating materials, for example, which crosslink by irradiation and form a continuous layer, more particularly a film or coating.

In order to obtain curability in the dispersion or solubilisate used in accordance with the invention, it is possible, in the context of the present invention, for the solubilisate or dispersion to have in general at least one curable, more particularly radiation-curable and/or thermally curable, preferably radiation-curable, component. Particularly good results in this context are obtained in particular when the solubilisate or dispersion has a reactive diluent as curable component. A reactive diluent in the context of the present invention is in particular a substance or a compound which in addition to the actual solvent or dispersion medium is added to the solubilisate or dispersion and has chemical functionalities which react chemically, under the conditions of curing, with other reactive diluent molecules and/or constituents of the solubilisate or dispersion. As a result of chemical reaction, in particular, a three-dimensional network is constructed, which leads to curing of the dispersion or solvent. Examples of reactive diluents contemplated include acrylates, polyurethane prepolymers, phenol/formaldehyde resins, unsaturated polyesters, etc.

In accordance with one preferred embodiment, moreover, in the context of the present invention, the solvent of the solubilisate or the continuous phase of the dispersion is curable, more particularly radiation-curable and/or thermally curable, preferably radiation-curable, in form. In this case, the curable component is the solvent of the solubilisate or the continuous phase of the dispersion, each of which may synonymously also be termed binder. Examples of radiation-curable binders which can be used are acrylates and/or methacrylates, polyurethane prepolymers, phenol/formaldehyde resins, melamine/formaldehyde resins, or unsaturated polyesters, whereas examples of thermally curable binders or components that can be used are, preferably, film-forming polyurethanes or polyvinylidene chloride (PVDC).

The solubilisate or dispersion may comprise the electrically conductive materials in amounts of 0.001 to 90 wt %, more particularly 0.005 to 80 wt %, preferably 0.01 to 50 wt %, more preferably 0.01 to 30 wt %, very preferably 0.01 to 20 wt %, based on the solubilisate and/or dispersion. The amount of electrically conductive materials present in the dispersions in each case is dependent on the particular end application, the application conditions, and the materials used.

In the context of the present invention, moreover, the solubilisate and/or dispersion may have at least one additive. In this context it has proven advantageous if the solubilisate and/or dispersion has the at least one additive in amounts of 0.01 to 60 wt %, more particularly 0.05 to 50 wt %, preferably 0.01 to 40 wt %, more preferably 0.05 to 30 wt %, very preferably 0.1 to 20 wt %, based on the solubilisate and/or dispersion.

This additive or these additives may be selected more particularly from the group consisting of dispersing assistants (dispersants) surfactants or surface-active substances, defoamers, rheology modifiers, binders, film formers, biocides, markers, pigments, fillers, adhesion promoters, flow control additives, cosolvents, antiskinning agents, UV absorbers, anticlogging agents and/or stabilizers.

Particularly good results are obtained in the context of the present invention if the solubilisate or dispersion has at least one wetting and/or dispersing agent. The use of wetting and/or dispersing agents raises the compatibility of substance to be solubilized or dispersed, and solvent or dispersion medium, respectively, to a considerable extent, and thus makes it possible to use dispersions having a significantly higher level of dissolved or dispersed substances.

Furthermore, in the context of the present invention, good results are obtained if the solubilisate or dispersion has at least one interface-active additive. It has been found appropriate in this context for the interface-active additive to be selected from the group consisting of lubricity and/or slip additives; flow control agents; surface additives, especially crosslinkable surface additives; adhesion promoters and/or substrate wetting additives; hydrophobizers, and antiblocking agents. The interface-active additives on the one hand increase the compatibility of the dispersion or solubilisate with the substrate, and hence lead to improved adhesion of the dispersion or solubilisate on the substrate, and also to an improved abrasion resistance; on the other hand, the interface-active additives further increase the compatibility of solvent/dispersion medium and dissolved or dispersed substance.

Provision may be made additionally for the solubilisate and/or the dispersion to have at least one rheology control additive. The rheology control additives influence, in particular, the consistency and viscosity of the solubilisate or dispersion, and hence also ensure that the solubilisate or dispersion can be adapted ideally to the particular application method and that running of the solubilisate or dispersion applied to the substrate is prevented. Particularly good results are obtained in this context if the rheology control additive is selected from the group consisting of rheology additives, especially thickeners and/or thixotropic agents; defoamers; dewatering agents; structuring agents, and also plasticizing agents and/or plasticizers.

Lastly, provision may also be made for the solubilisate and/or dispersion to comprise at least one additive which may be selected from the group consisting of corrosion inhibitors; light stabilizers, especially UV absorbers, radical scavengers, quenchers and/or hydroperoxide destroyers; dryers; antiskinning agents; catalysts; accelerators; biocides; preservatives; scratch resistance additives; antistats; siccatives; waxes; fillers and pigments. These further additives or auxiliaries may round out the properties of the solubilisate or dispersion in relation to application and also to further use.

Provision may be made in particular here for the solubilisate or dispersion to comprise fillers, such as barium sulphate or talc, for example, and/or to comprise conductive pigments, which also raise the conductivity of the solubilisate or dispersion.

Generally speaking, the substrate is an organic and/or inorganic substrate. Particularly good results are obtained in this context if the substrate is selected from the group consisting of glass, ceramic, silicones, clays, waxes, plastics, and composite materials. The solubilisate or dispersion based on electrically conductive materials is applied to the substrates used in accordance with the invention, and subsequently (optionally after an interim drying and/or curing step) metals may be deposited, optionally, electrochemically on the conductive structures. After the metals have been deposited, it is possible for the substrate to be separated from the objects obtained by galvanoforming, more particularly the electroformed products. These substrates may either be separated off in such a way that they are maintained, or else, as in the case of conventional electroforming, may be destroyed, by being dissolved in solvents or melted in the case of wax-based substrates, for example.

The substrate used in accordance with the invention may be a two-dimensional substrate, more particularly a sheetlike substrate, or else a three-dimensional substrate. Two-dimensional substrates are used, for example, in the production of conductor tracks, whereas three-dimensional substrates are employed in order to produce precision-mechanical components or workpieces.

In the context of the present invention, particularly good results are obtained if the solubilisate and/or dispersion is applied by means of printing methods to the substrate. The use of printing methods permits high throughput and outstanding precision in the production of the electrically conductive structures according to the invention, and also simple and flexibly employable application of the solubilisate or dispersion, particularly in a locally limited or regioselective way. For applying the solubilisate or dispersion, use may be made here, in accordance with the invention, of a conventional printing method, such as gravure methods, flexographic methods or offset methods, for example, ensuring a very high throughput in the printing of preferably two-dimensional substrates. In addition, however, electronic printing methods may also be employed, such as inkjet printing methods and toner-based printing methods (using laser printers, for example), for example. Particularly preferred in this context is the inkjet printing method, since with this method even three-dimensional substrates can be reproducibly printed in a simple and flexible way.

The particular printing method used is dependent on the nature of the substrate and on the particular end use. Common to all printing methods, however, is the fact that the solubilisate or dispersion, at least during application or when being applied, passes through the liquid aggregate state; in other words, even when viscous pastes and clays are used, they are melted, so to speak, during the printing operation, and applied in liquid form to the substrate.

Moreover, in the context of the present invention, it may be the case that the solubilisate and/or dispersion is applied by means of a mask to the substrate. Application by means of a mask means here, in the context of the present invention, more particularly that defined regions of the substrate are covered and hence do not come into contact with the solubilisate or dispersion when the solubilisate or dispersion is applied in a surface-covering manner, such as by spray application, for example. Such a spray application is appropriate, for example, if the dispersion is present in the form of a powder coating material. Likewise, however, masks can also be employed in the application of liquid or pasty solubilisates or dispersions, particularly if, for example, particularly sharp or exact or precise boundary lines of the solubilisate or dispersion on the substrate are to be obtained.

As far as the temperature is concerned at which the solubilisate or dispersion is applied in the context of the present invention, it may vary within wide ranges. Generally speaking, the solubilisate or dispersion is applied at temperatures in the range from 0 to 300° C., more particularly 0 to 200° C., preferably 5 to 200° C., more preferably 10 to 100° C., very preferably 15 to 80° C. The specific application temperature here is guided in particular by the temperature sensitivity of the substrate, by the application method employed, more particularly print method, and also by the properties of the solubilisate or dispersion; in particular, pasty and solid dispersions ought in general to pass through the liquid aggregate state as well, in order to ensure uniform and thin application.

As far as the viscosity of the solubilisate or dispersion is concerned, it may likewise vary within wide ranges. The dynamic viscosity as determined to DIN EN ISO 2431 may be within the range from 5 to 1 100 000 mPas, more particularly in the range from 5 to 100 000 mPas, preferably in the range from 5 to 50 000 mPas, more preferably in the range from 7 to 1000 mPas, very preferably in the range from 7 to 500 mPas, especially preferably in the range from 7 to 300 mPas. The precise value of the viscosity of the solubilisate or dispersion is guided here primarily by the application methods that are used, more particularly printing methods: thus, for example, for the offset printing method, dynamic viscosities in the region of around 1 000 000 mPas are needed for the dispersion or solubilisate to be applied, whereas solubilisates and dispersions of the kind that may be used for inkjet printing methods can have dynamic viscosities of 10 mPas or less.

Generally speaking, in the context of the present invention, the solubilisates or dispersions are applied with a film thickness of 0.05 to 200 μm, more particularly 0.1 to 50 μm, preferably 0.5 to 30 μm, more preferably 1 to 20 μm, very preferably 2 to 15 μm, to the substrate.

It may also be envisaged in accordance with the invention for the electrically conductive structure in the context of the present invention, after method steps (a) and/or (b) have been carried out, to have a film thickness of 0.01 to 100 μm, more particularly 0.05 to 50 μm, preferably 0.1 to 30 μm, more preferably 0.2 to 20 μm, very preferably 0.3 to 10 μm, especially preferably 0.4 to 5 μm, even more preferably 0.5 to 3 μm, more preferably still 0.6 to 2 μm. In the context of the present invention, therefore, extremely thin layers of conductive materials can be realized on substrates, which despite this possess an outstanding mechanical robustness, especially abrasion resistance, and also an excellent electrical conductivity.

As far as the mechanical robustness of the electrically conductive structures obtainable by the method of the invention is concerned, these structures are notable in particular for a high abrasion resistance. Accordingly, the electrically conductive structure, after method steps (a) and/or (b) and/or (c) have been carried out, may have a Taber abrasion resistance to DIN EN ISO 438 of at least index 2, more particularly at least index 3, preferably at least index 4.

Equally, provision may be made for the electrically conductive structure, after method steps (a) and/or (b) have been carried out, to have a wet abrasion resistance to EN 13300 of at least class 4, more particularly at least class 3, preferably of class 1 or 2.

The electrically conductive structures according to the invention may therefore have abrasion resistances of the kind that occur, for example, in highly durable and resistant varnishes.

The electrical conductivity of the electrically conductive structures may also vary within wide ranges in the context of the present invention; in particular, a distinction must be made between the conductivities of the structures based on the non-metal-based solubilisates or dispersions, on the one hand, and the electrical conductivities of the structures after the electrochemical deposition of metals.

All of the values reported below for the resistivity relate in particular to a temperature of measurement or determination of 20° C. The determination may be made, for example, according to the four-pole method or four-point method and/or in accordance with DIN EN ISO 3915.

Thus, in the context of the present invention, the electrically conductive structures, after method steps (a) and/or (b) have been carried out, may have a resistivity ρ in the range from 10⁻⁷ Ωm to 10¹⁰ Ωm, more particularly in the range from 10⁻⁶ Ωm to 10⁵ Ωm, preferably in the range from 10⁻⁵ Ωm to 10³ Ωm.

After the optionally implemented method step (c) of the electrochemical depositions of metals, in contrast, the electrically conductive structures may have a resistivity ρ in the range from 10⁻⁹ Ωm to 10⁻¹ Ωm, more particularly in the range from 10⁻⁸ Ωm to 10⁻² Ωm, preferably in the range from 10⁻⁷ Ωm to 10⁻³ Ωm.

As far as the deposition of the metal in method step (c) is concerned, the metal to be deposited generally comprises at least one transition metal, more particularly a noble metal or a metal from the group of the lanthanides. In the context of the present invention, there may expressly also be a co-deposition of two or more metals, allowing access to alloys having specific properties.

In the context of the present invention, particularly good results are obtained if the metal or metals are selected from transition groups I, V, VI, and VIII of the Periodic Table of the elements. Preference here is given to the electrochemical deposition on the substrate of a metal or of two or more metals from the group consisting of Cu, Ag, Au, Pd, Pt, Rh, Co, Ni, Cr, V, and Nb.

Generally speaking, especially in method step (c), the metal is deposited from a solution of the metal. The solutions of the metals are, customarily, in particular, aqueous solutions of metal salts, although it is also possible for solutions containing metal ions and based on aqueous-organic or organic solvents, or else, alternatively, salt melts, such as ionic liquids, for example, to be used.

Furthermore, in the context of the present invention, the metal is deposited, more particularly electrodeposited, generally by application of an external electrical voltage, more particularly by electrolysis.

For the deposition of the metal it has proven advantageous, furthermore, if the metal is deposited with current densities in the range from 1 to 10 mA/cm², more particularly 2 to 8 mA/cm², preferably 3 to 6 mA/cm².

Through the procedure according to the invention it is possible for the metal to be deposited flexibly and in a manner adapted to the particular end application with a layer thickness of 1 nm to 8000 μm, more particularly 2 nm to 4000 μm, preferably 5 nm to 2 500 μm, more preferably 10 nm to 2000 μm, very preferably 50 nm to 1000 μm. In this way, on the one hand, extremely thin conductor tracks and microstructures are obtainable; on the other hand, however, precision-mechanical components as well can be obtained with sufficient stability.

In the context of the present invention it is possible, moreover, for the metallic structure obtained by electrochemical deposition, more particularly in method step (c), to be subjected to a finishing treatment, more particularly in a method step (d). Particularly good results here are obtained if the finishing treatment takes place by etching, polishing, sputtering, encapsulating, filling, or coating. The finishing treatment, more particularly in method step (d), has the aim of optimizing the resultant metallic structures in terms of their profile of properties, and/or of preparing them for any subsequent operations. In particular, for example, minor irregularities formed during galvanizing at the contact points of the electrodes can be compensated, for example, or electrical components can be encapsulated in a resin, such as an epoxy resin, for example, in order to protect against mechanical exposure and environmental influences, for example.

The conductive structures, more particularly metallic structures, obtainable by the method of the invention are distinguished relative to the structures and objects or workpieces obtainable hitherto in accordance with the prior art in a particular regularity of the layer application. This is so in particular both in respect of the nonmetallic conductive structures of the invention and in respect of the metallic conductive structures of the invention.

In addition, the conductive structures obtainable by the method of the invention possess an increased abrasion resistance by comparison with the conductive structures known to date in the prior art, and this is attributable in particular to enhanced adhesion or attachment of the solubilisate or dispersion used in accordance with the invention.

The conductive structures obtainable in accordance with the invention are also not only more stable—that is, more abrasion-resistant and scratch-resistants—than the structures known to date in the prior art, but are also notable, moreover, for an increased elasticity, which is manifested in significantly improved flexural strengths.

Owing to the thin-layer application of the solubilisate or dispersion, the method of the invention can be used to produce or reproduce particularly finely structured, more particularly microstructured, and miniaturized structures and objects or workpieces with a high level of detail by galvanoforming. This is true in particular of the use of carbon nanotubes (CNTs) as electrically conductive starting materials, which on account of their high conductivity and high aspect ratio (i.e., the ratio of length to diameter) need be applied only at extremely low concentrations and layer thicknesses in order that percolation and hence a comprehensive conductivity is achieved.

Additionally provided for the present invention—in accordance with a second aspect of the present invention—are, accordingly, electrically conductive (i.e., electrically conductive metallic) structures which are obtainable by the method described above.

Provided in particular by the present invention in accordance with this aspect of the present invention are electrically conductive metallic structures which comprise a nonconducting substrate bearing at least partly at least one electrically conductive material selected from the group consisting of electrically conductive carbon allotropes, electrically conductive polymers, and electrically conductive inorganic oxides, there being at least one metal deposited electro-chemically in turn on the electrically conductive material.

As already observed above, the conductive metallic structures of the invention as well are notable for particularly low layer thicknesses and a high regularity in tandem with excellent conductivity and also outstanding mechanical properties.

For further details of this aspect of the invention, reference may be made to the observations made in relation to the method of the invention, which apply correspondingly in this respect.

Provided yet further by the present invention—in accordance with a third aspect of the present invention—is the use of the above-described electrically conductive structures in electrical engineering or electronics.

Generally speaking, the conductive structures of the invention can be used in the computer and semiconductor industry and also in metrology.

Particularly good results here are obtained if the conductive structures of the invention are used for producing conductor tracks, microstructured components, precision-mechanical components, and electronic or electrical components.

For further details on this aspect of the present invention, reference may be made to the above observations concerning the other aspects of the invention, which apply correspondingly in relation to this inventive use.

Provided yet further by the present invention—in accordance with a fourth aspect of the present invention—is the use of the above-described conductive structures for producing metallic structures.

The conductive structures of the invention are especially suitable for producing two-dimensional and/or three-dimensional metallic structures, more particularly for galvanoforming.

Furthermore, the conductive structures of the invention may be used specifically for producing electroformed products and/or for producing decorative elements.

For further details on this aspect of the invention, reference may be made to the above observations concerning the other aspects of the invention, which apply correspondingly in this respect.

Provided additionally and lastly by the present invention—in accordance with a fifth aspect of the present invention—are conductor tracks, micro-structured components, precision-mechanical components, electronic or electrical components, microstructures, decorative elements, or electroformed products which comprise an electrically conductive structure according to the invention.

For further details on this aspect of the invention, reference may be made to the above observations concerning the other aspects of the invention, which apply correspondingly in this respect.

Further embodiments, modifications and variations of the present invention are immediately recognizable and realizable to a person skilled in the art on reading the description, without departing the scope of the present invention.

The present invention is illustrated using the working examples which follow, but without the present invention being restricted thereto.

### WORKING EXAMPLES

### Example 1

### Use of a CNT Dispersion to Produce Electroformed Products

A wax positive of a key fob was coated thinly, with a wet film thickness of about 30 to 40 μm, with a CNT dispersion (2 wt % CNTs in methoxypropyl acetate (PMA)), and the coating was subsequently dried. The specimen was contacted with the current source through an insulated copper cable, which was plugged into the wax body and had contact with the conductive CNT dispersion. The specimen prepared in this way was immersed fully into a copper sulfate solution. A piece of pure copper served as the anode. Even with a low current strength (0.5 A; constant voltage), a thin layer of copper formed on the specimen after a short time, and increased in weight in dependence on time and current strength. After the end of the galvanizing operation, the specimen was placed in an oven at about 100° C. in order to remove the wax. By careful removal of the oxide layer, the underlying, metallically lustrous copper was made visible. With this technique it is possible to model even fine three-dimensional structures.

### Example 2

### Use of an Aqueous Baking Varnish for Producing Metallically Conductive Layers and Conductor Tracks

An aqueous baking varnish of Bayhydrol® E 155 type was functionalized and made electrically conductive with a dispersion of 8 wt % CNTs in methoxypropyl acetate (PMA). An electrical circuit plan was applied, using the functionalized Bayhydrol® E 155, to a thin PET film, by means of ink-jet methods. In the same way as for Example 1, a thin layer of copper was deposited on the coated areas of the film. At the uncoated areas, no copper was deposited, and these areas therefore remained electrically insulating.

### Example 3

### Use of a Solvent-Based CNT Dispersion for Producing Metallic Moldings (Including Detachment of the Moldings from the Film/Glass)

A dispersion of 2 parts by weight of CNTs in 98 parts by weight of methoxypropyl acetate (PMA) was used to model a test specimen for a tensile test on a polyethylene substrate (PE substrate).

In the case of the pure dispersion, the adhesion to the PE substrate is poorer than the adhesion, for example, of the functionalized baking varnish. This circumstance can be used to allow the specimen to be detached easily from the substrate following the deposition of the copper onto the coated areas.

### Example 4

### Comparison of the Abrasion Resistance and Resistivity of Conductive Nonmetallic Structures

In order to compare the abrasion resistance and resistivity of various nonmetallic conductive materials, 2 parts by weight each of graphite or carbon nanotubes (multiwall carbon nanotubes (MWCNTs)) or indium tin oxide (ITO) or polyaniline were dispersed in 97 parts by weight of methoxypropyl acetate (PMA) in the presence of 1 part by weight of a polymeric wetting and dispersing assistant having a molecular weight of more than 2000 g/mol.

The dispersions were applied by means of ink-jet methods, with a layer thickness of 25 to 30 μm, to a glass plate, and the dispersion medium was subsequently removed. For comparison, another glass plate was dusted with elemental graphite in powder form. Subsequently, on all of the samples, the resistivity of the coating and also the Taber abrasion resistance to DIN EN ISO 438 were ascertained. The results are compiled in table 1 below.

The results in table 1 show that the application of elemental graphite in powder form to a substrate does result in conductivities comparable to those from the application of a graphite dispersion, but that the graphite dispersion of the invention exhibits a significantly higher abrasion resistance. Moreover, the values in table 1 demonstrate that with carbon nanotubes it is possible to obtain significantly lower values for the resistivity and hence significantly higher specific conductivities in conjunction with significantly improved abrasion resistance—which is comparable with that of mechanically resistant varnishes.

TABLE 1

| | | Abrasion |
|---|---|---|
| Conductive | Resistivity | resistance to |
| material | [Ωm] | DIN EN ISO 438 |
| Graphite_{powder} | 7.0 × 10⁻⁴ | 1 |
| (comparative) | | |
| Graphite_{dispersion} | 6.5 × 10⁻⁵ | 3 |
| (inventive) | | |
| CNTS_{dispersion} | 3.2 × 10⁻⁶ | 5 |
| (inventive) | | |
| Indium tin | 1.2 × 10⁻² | 3 |
| oxide_{dispersion} | | |
| (inventive) | | |
| Polyaniline_{dispersion} | 2 × 10⁻² | 4 |
| (inventive) | | |

1-20. (canceled)

21. A method for electrochemical deposition of metals on substrates for producing metallic structures or electroformed products,
wherein the method comprises the following steps:
in a first method step (a), at least one solubilisate or dispersion based on electrically conductive materials selected from the group consisting of electrically conductive carbon allotropes, electrically conductive polymers and electrically conductive inorganic oxides, is applied to an electrically nonconducting substrate, wherein the application of the solubilisate or dispersion is carried out with local limitation or locational specificity by means of printing methods, with the solubilisate or dispersion being applied with a film thickness of 0.5 to 30 •m to the substrate,
in a subsequent method step (c), at least one metal is deposited electrochemically on the solubilisate or dispersion.

22. The method as claimed in claim 21, wherein after the first method step, a method step (b) of drying or curing the solubilisate or dispersion is carried out before the electrochemical deposition of the metal.

23. The method as claimed in claim 21,
wherein the electrically conductive carbon allotropes used are selected from the group consisting of graphite, graphenes, fullerenes and carbon nanotubes (CNTs);
wherein the electrically conductive polymers used are selected from the group consisting of polyacetylenes, polyanilines, polyparaphenylenes, polypyrroles and polythiophenes;
wherein the electrically conductive inorganic oxides used are selected from the group consisting of indium tin oxide (ITO), indium zinc oxide (IZO), aluminum zinc oxide (AZO), antimony tin oxide (ATO) and fluorine tin oxide (FTO).

24. The method as claimed in claim 21,
wherein the solubilisate or dispersion is water-based or solvent-based, wherein the solvent of the solubilisate or the continuous phase of the dispersion is an aqueous-based, organic-based or organic-aqueous-based solvent or dispersion medium, or else wherein the dispersion is a powder coating material.

25. The method as claimed in claim 21,
wherein the solubilisate or dispersion is curable;
wherein the solubilisate or dispersion comprises at least one curable component.

26. The method as claimed in claim 21,
wherein the solubilisate or dispersion comprises the electrically conductive materials in amounts of from 0.001 to 90 wt %, based on the solubilisate or dispersion.

27. The method as claimed in claim 21,
wherein the solubilisate or dispersion comprises at least one additive in amounts of from 0.001 to 60 wt %, wherein the additive is selected from the group of dispersants, surfactants, surface-active substances, defoamers, rheology modifiers, binders, film formers, biocides, markers, pigments, fillers, adhesion promoters, flow control additives, cosolvents, antiskinning agents, UV absorbers, anticlogging agents, stabilizers and mixtures thereof.

28. The method as claimed in claim 21,
wherein the solubilisate or dispersion comprises at least one wetting or dispersing agent.

29. The method as claimed in claim 21,
wherein the solubilisate or dispersion comprises at least one interface-active additive selected from the group consisting of lubricity and slip additives, flow control agents, surface additives, crosslinkable surface additives, adhesion promoters, substrate wetting additives, hydrophobizers, antiblocking agents and mixtures thereof.

30. The method as claimed in claim 21,
wherein the solubilisate or dispersion comprises at least one rheology control additive selected from the group of rheology additives, thickeners, thixotropic agents, defoamers, dewatering agents, structuring agents, plasticizing agents, plasticizers and mixtures thereof.

31. The method as claimed in claim 21,
wherein the solubilisate or dispersion comprises at least one additive selected from the group consisting of corrosion inhibitors, light stabilizers, UV absorbers, radical scavengers, quenchers, hydroperoxide destroyers, dryers, antiskinning agents, catalysts, accelerators, biocides, preservatives, scratch resistance additives, antistats, siccatives, waxes, fillers, pigments and mixtures thereof.

32. The method as claimed in claim 21,
wherein the substrate is an inorganic or organic substrate selected from the group consisting of glass, ceramic, silicones, clays, waxes, plastics, and composite materials and wherein the substrate is a two-dimensional or a three-dimensional substrate.

33. The method as claimed in claim 21,
wherein the solubilisate or dispersion is applied by means of inkjet printing methods, gravure methods, flexographic methods, offset methods, toner-based printing methods.

34. The method as claimed in claim 21,
wherein the solubilisate or dispersion is applied at temperatures of from 0 to 300° C.;
wherein the dispersion has a dynamic viscosity as determined according to DIN EN ISO 2431 in the range from 5 to 1 100 000 mPas;
wherein the dispersion is applied with a film thickness of 0.5 to 30 •m.

35. The method as claimed in claim 21,
wherein the electrically conductive structure, after method step (a) or (b) has been carried out, has a film thickness of 0.01 to 100 •m;
wherein the electrically conductive structure, after method step (a), (b) or (c) has been carried out, has a Taber abrasion resistance according to DIN EN ISO 438 of at least index 2;
wherein the electrically conductive structure, after method step (a) or (b) has been carried out, has a wet abrasion resistance according to EN 13300 of at least class 4;
wherein the electrically conductive structure, after method step (a) or (b) has been carried out, has a resistivity • in the range from 10⁻⁷ •m to 10¹⁰ •m;
wherein the electrically conductive structure, after method step (c) has been carried out, has a resistivity • in the range from 10⁻⁹ •m to 10⁻¹ •m.

36. The method as claimed in claim 21,
wherein the metal to be deposited in method step (c) comprises at least one transition metal selected from the group consisting of Cu, Ag, Au, Pd, Pt, Rh, Co, Ni, Cr, V and Nb;
wherein the metal is deposited from a solution of the metal with a layer thickness of 1 nm to 8000 •m;
wherein the metal is deposited by application of an external electrical voltage and with current densities of 1 to 10 mA/cm².

37. The method as claimed in claim 21,
wherein the metallic structure obtained by electrochemical deposition in method step (c) is subjected to a finishing treatment by etching, polishing, sputtering, encapsulating, filling or coating.

38. Electrically conductive metallic structures obtained by a method as claimed in claim 21.

39. The electrically conductive metallic structures as claimed in claim 38, comprising a nonconducting substrate on which at least partly at least one electrically conductive material selected from the group consisting of electrically conductive carbon allotropes, electrically conductive polymers and electrically conductive inorganic oxides has been applied by means of printing processes, wherein at least one metal has been deposited electrochemically on the electrically conductive material.

40. Electrocomponents selected from the group consisting of conductor tracks, microstructured components, precision-mechanical components, electronic and electrical components, microstructures, decorative elements and electroformed products, comprising an electrically conductive structure as claimed in claim 38.
